(19) United States
(12) Patent Application Publication
(10) Pub. No.: US 2021/0005940 A1
(43) Pub. Date: Jan. 7, 2021

(54) Portable Lithium-Titanate Battery and Charger

(71) Applicant: ZapBatt, Inc., Hermosa Beach, CA (US)

(72) Inventor: Charles Welch, Hermosa Beach, CA (US)

(21) Appl. No.: 16/946,745

(22) Filed: Jul. 2, 2020

Related U.S. Application Data
(60) Provisional application No. 62/869,975, filed on Jul. 2, 2019.

(51) Int. Cl. H01M 10/44; H02J 7/00; H01M 10/052

(52) U.S. Cl. CPC H01M 10/448; H01M 10/052; H02J 7/007182; H02J 7/00714

(57) ABSTRACT

An electronic circuit that very rapidly charges an internal lithium-titanate battery that can then be used to power an external low-power electronic device and/or charge the external electronic device's internal battery.

### CROSS REFERENCES TO RELATED APPLICATIONS

The present application claims the benefit of U.S. Provisional Patent Application Ser. No. 62/869,975, filed Jul. 2, 2019 (Jul. 02, 2019), which application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### SEQUENCE LISTING

Not applicable.

### BACKGROUND OF THE INVENTION

### Field of the Invention

The present invention relates generally to batteries and their charging methods, and more particularly to a method and article for very rapidly charging a lithium-titanate battery.

### Background Discussion

In current art, many low-power electronic devices (such as cell phones, wireless earphones, etc.) are powered by internal batteries. Typically, Lithium-Ion batteries are used that require low-current charging cycles that often take hours to become fully charged.

These types of low-power electronic devices can be charged from an external source using a vendor-supplied power supply. While charging, many of these low-power electronic devices can also be operated, as long as the charging source is capable of keeping the charge voltage above a given threshold, as well as being able to provide sufficient current to operate the device's circuitry while charging the device's internal battery.

When charging their internal battery, most low-power electronic devices have an internal battery-charging circuit that connect to a commercial 110 VAC or 240 VAC power source through a “wall wart” voltage transformer box plugged into a wall socket. This configuration constrains the user of the device to a limited physical area of charging and/or operation, limited by the length of cable that connects the “wall wart” box to the device's battery charging power input connector.

This can create a frustrating situation for the user when the internal battery of the electronic device becomes discharged at an inconvenient time, or at a location where there is no external commercial power available, or at a location where commercial power is available, but there is not sufficient time available for fully charging the electronic device's internal battery (due to the long charging cycle of that battery).

When charging a battery cell, that battery cell will have an impedance or resistance to charge input based on its state of charge and other factors. Typically charging circuits will use a charging circuit that delivers a constant current, then at the very end of the cycle charges at a constant voltage, which allows the current to taper down as the battery becomes fully charged. What this means simply is that the standard method uses a fixed ratio for charging a battery cell; it is not actively monitoring the cell to determine if there is the possibility for higher current input, because almost all battery cells cannot handle high current input in the first place.

The foregoing patents reflect the current state of the art of which the present inventors are aware. Reference to, and discussion of, these patents is intended to aid in discharging Applicants' acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is an electronic circuit that charges a single-cell lithium-titanate battery, having one or more inputs that provide power for charging the lithium-titanate battery cell, and also an output for transferring power from the lithium-titanate battery to an external device (i.e., a cellphone, wireless headphones, portable battery pack, etc.). The electronic circuit manages the charging of the lithium-titanate battery in such a way that even a fully depleted battery is charged in the minimum time practicable (typically less than 15 minutes).

The present invention performs real-time continuous monitoring of the battery voltage, charging current, and internal resistance in order to determine precisely when to increase the charging current to its internal lithium-titanate battery to reduce the time it takes for the battery to become fully charged (maximum of 15 minutes, but also as few as 5 minutes).

In a portable version of the invention, when the lithium-titanate battery is sufficiently charged, the USB output of the invention is able to be connected to the charging input port of an external electronic device in order to charge the device's internal battery while also allowing the device to operate from voltage and current provided by the invention.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a block diagram of the circuitry of the invention;

FIG. 2 includes FIGS. 2A-2B (divided left to right), which together form a schematic drawing of the Programmable Current Source portion of the electronic circuit of the invention, the division shown;

FIG. 3 is a schematic drawing of the 5 VDC-to-12 VDC Conversion portion of the electronic circuit of the invention;

FIG. 4 is a schematic drawing of the Boost Converter portion of the electronic circuit of the invention, showing also the USB connector used as the output connection of the invention;

FIG. 5 is a schematic drawing of the 12 VDC/5 VDC-to-3.3 VDC Converter portion of the electronic circuit of the invention;

FIG. 6 is a schematic drawing of the OLED Display portion of the electronic circuit of the invention;

FIG. 7 is a schematic drawing of the Microcontroller portion of the electronic circuit of the invention;

FIG. 8 is a schematic drawing of the OPAMP Board portion of the electronic circuit of the invention; and

FIG. 9 includes FIGS. 9A-9D (divided left to right), which together form a truth table showing how functional values are processed and decisions and actions taken in accordance with the functions of the invention herein, with the general functions of the microcontroller set out particularly in FIG. 9D.

### DETAILED DESCRIPTION OF THE INVENTION

### Circuit Hardware Description

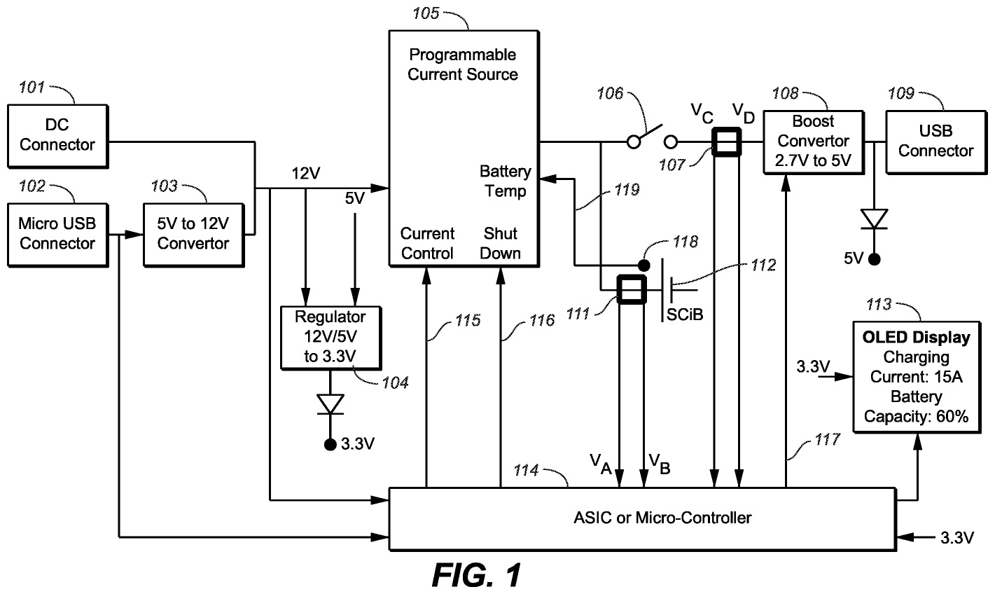

The components of the electronic circuit hardware of this invention that are shown in FIG. 1 through FIG. 8 are described below.

Referring to the block diagram shown in FIG. 1, it can be seen that microcontroller 114 is used to monitor several electronic circuit conditions, as well as to control the operation of several circuit components of the invention. Note that an ASIC can be used in place of microcontroller 114 to provide control of the invention circuitry.

FIG. 1 shows an input DC connector 101 that is connected to, and receives power from, an external 12 VDC 6 A power source. From input DC connector 101, the 12 VDC input power is sent to the input of programmable current source circuit 105. An alternate 5 VDC external input power source can also be received through micro USB connector 102. When a 5 VDC power source is connected to micro USB connector 102, 5V to 12V convertor circuit 103 upconverts the voltage to 12 VDC, which is sent to the input of programmable current source circuit 105.

The presence of the 12 VDC input power is sensed by microcontroller 114, so the firmware operating on microcontroller 114 can know when this voltage is present. Additionally, the 5 VDC input power is sensed by microcontroller 114, so the firmware operating on microcontroller 114 can know when this voltage is present.

The 12 VDC input power is also sent to an input of 12V/5V to 3.3V regulator circuit 104. Additionally, the feed of 5 VDC output power from boost convertor circuit 108 is sent to an input of 12V/5V to 3.3V regulator circuit 104. 12V/5V to 3.3V regulator circuit 104 downconverts both the 12 VDC input power and 5 VDC output power to 3.3 VDC. The 3.3 VDC is used to power microcontroller 114 as well as OLED display 113.

The output current of programmable current source circuit 105 is controlled by microcontroller 114 through programmable current control line 115. The voltage level (between 0 VDC and 1.5 VDC) present on programmable current control line 115 determines the amount of current provided to the output of programmable current source circuit 105. Microcontroller 114 also provides an enable/disable input to programmable current source circuit 105 via programmable current source enable/disable line 116. Enable/disable line 116 is used by microcontroller 114 to disable the output of programmable current source circuit 105 under certain conditions.

Programmable current source circuit 105 provides the current source (0 A to 15 A) that is used to charge lithium-titanate battery 112. Lithium-titanate battery 112 is a single 2.8V cell that can produce up to 5 A of output current. The internal construction and chemistry of lithium-titanate battery 112 allows high-current rapid charging of the battery. Microcontroller 114 controls the output current of programmable current source circuit 105 during the charge cycle of lithium-titanate battery 112 in a way that minimizes the time required for fully charging the battery, while also maintaining safe charging conditions.

Programmable current source circuit 105 also receives an analog voltage input from temperature sensing resistor network 118. The voltage produced by temperature sensing resistor network 118 represents the temperature of lithium-titanate battery 112, and is used by programmable current source circuit 105 to determine whether the immediate value of its output current is causing overheating of lithium-titanate battery 112 or any of the charging circuitry. If the voltage produced by temperature sensing resistor network 118 indicates overtemperature conditions, programmable current source circuit 105 will reduce its output current in order to prevent damage to lithium-titanate battery 112.

Microcontroller 114 also receives voltages Va and Vb as produced on the opposite sides of resistive circuit 111, as well as voltages Vc and Vd as produced on the opposite sides of resistive circuit 107. During the lithium-titanate battery 112 charging cycle, the values of voltages Va and Vb are used by microcontroller 114 to determine the amount of current flowing into lithium-titanate battery 112, as well as the instantaneous voltage of lithium-titanate battery 112. An additional determination of the internal resistance of lithium-titanate battery 112 is made by microcontroller 114 based on the values of voltages Va and Vb. During the discharge (battery output) cycle, the values of voltages Vc and Vd are used by microcontroller 114 to determine the amount of current flowing into boost convertor circuit 108 from lithium-titanate battery 112.

When switch 106 is closed, lithium-titanate battery 112 discharges into boost convertor 108. Boost convertor circuit 108 upconverts the 2.8 VDC output from lithium-titanate battery 112 to a 5 VDC output (up to 5 A current) from the invention. The 5 VDC output from boost convertor circuit 108 is connected to USB connector 109. External devices can be connected to USB connector 109 to utilize the output 5 VDC power provided by boost convertor circuit 108.

An additional function of microcontroller 114 is to control the output of OLED display 113. OLED display 113 presents information to the user of the present invention, including (but not necessarily limited to): (a) Remaining capacity of lithium-titanate battery 112; (b) charging current being used to charge lithium-titanate battery 112; (c) discharging current from lithium-titanate battery 112; (d) input current being provided to 5V output of boost convertor 108; (e)output current being provided by 5V output of boost convertor 108.

The firmware operating on microcontroller 114 determines what is shown on OLED display 113 based on circuit conditions as interpreted by the instantaneous values of voltages Va, Vb, Vc, and Vd. Further details about the firmware operating on microcontroller 114 are provided in a later section of this disclosure.

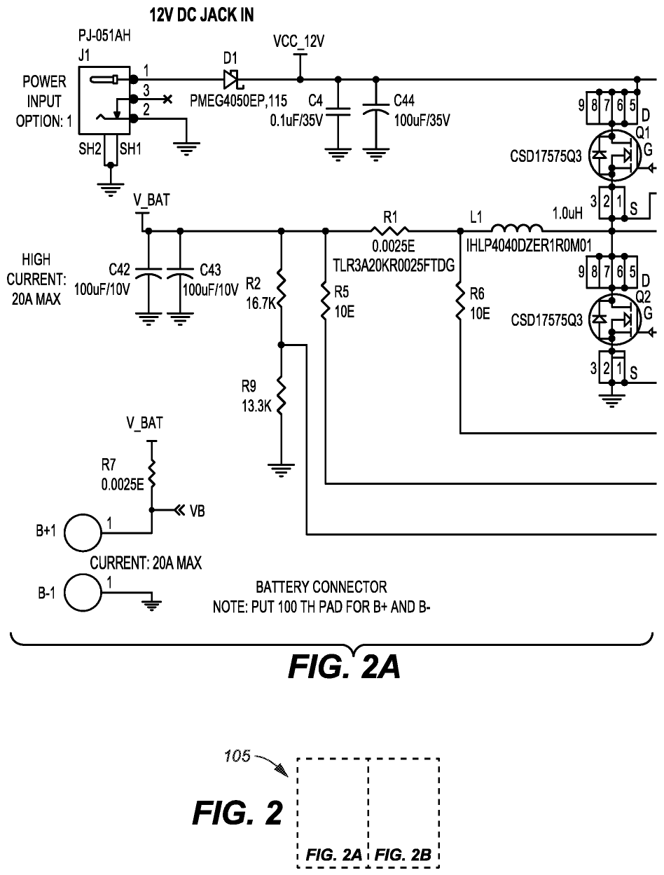

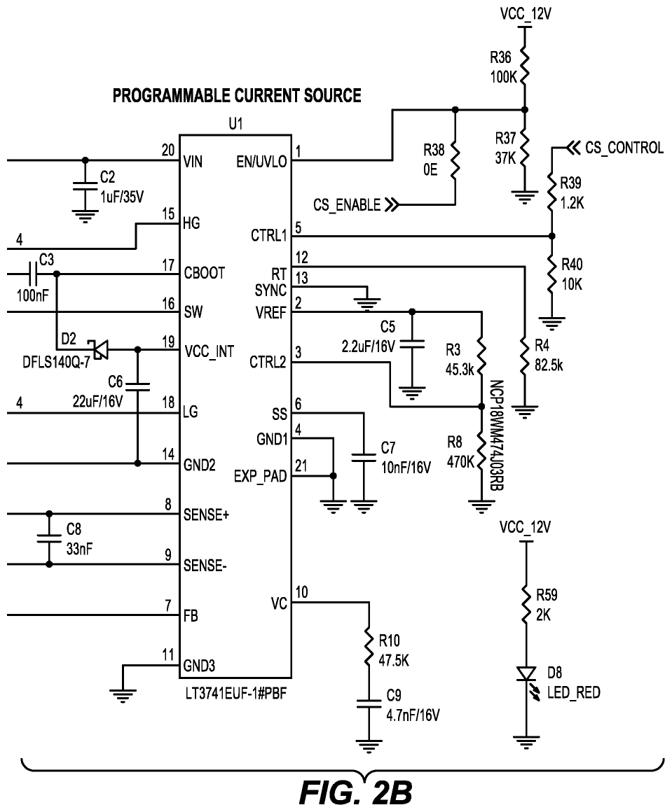

Now referring to FIG. 2, a detailed schematic drawing of programmable current source circuit 105 of FIG. 1 is shown. This circuit uses a programmable current controller U1 (in this embodiment, an Analog Devices part number LT3741EUF-1#PBF) to control the current flow through buck converter Q1 and buck converter Q2, thus providing control over the current that is used when charging lithium-titanate battery 112. The charging current originates from an external 12 VDC power source connected to DC connector 101 (seen as jack J1 in the schematic of FIG. 2). After passing though diode D1, the current then enters pin 20 (VIN) of programmable current controller U1. The charging current then flows from pin 16 (SW) of programmable current controller U1 through inductor L1, resistor R1, and resistor R7 into the positive side of lithium-titanate battery 112. In this embodiment, buck converters Q1 and Q2 are each a Texas Instruments part number CSD17575Q3 30-V N-Channel NexFET Power MOSFET. The well-known support components for programmable current controller U1 and buck converters Q1 and Q2 can also be seen in the circuit detailed in the schematic of FIG. 2.

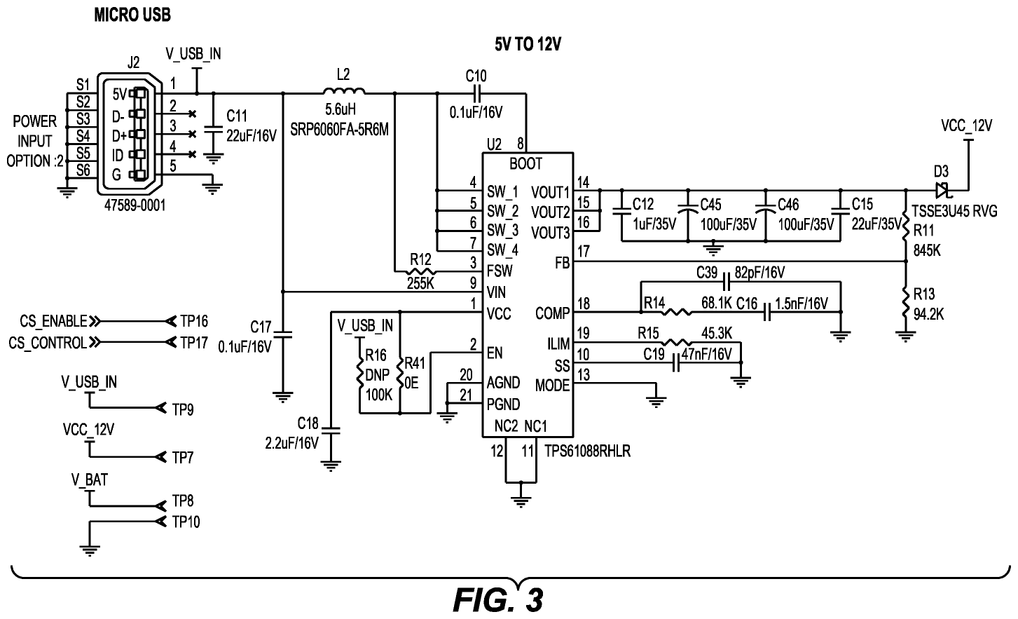

Now referring to FIG. 3, a detailed schematic drawing of 5V to 12V convertor circuit 103 of FIG. 1. upconverts the voltage to 12 VDC, which is sent to the input of programmable current source circuit 105. It can be seen that 5 VDC power is received via pin 1 of micro USB connector 102 of FIG. 1, seen as jack J2 in the detailed schematic of FIG. 3. From pin 1 of jack J1, the 5 VDC is applied to pin 9 (VIN) of 5V to 12V converter U2. In this embodiment, 5V to 12V converter U2 is a Texas Instruments part number TPS61088 10 (a fully-integrated synchronous boost converter). The 12 VDC output of the circuit is found on pin 14 (VOUT1) of 5V to 12V converter U2, where it then passes through diode D3 and is then provided as the VCC 12V used by other circuit components of the present invention. The well-known support components for 5V to 12V converter U2 can also be seen in the circuit detailed in the schematic of FIG. 3.

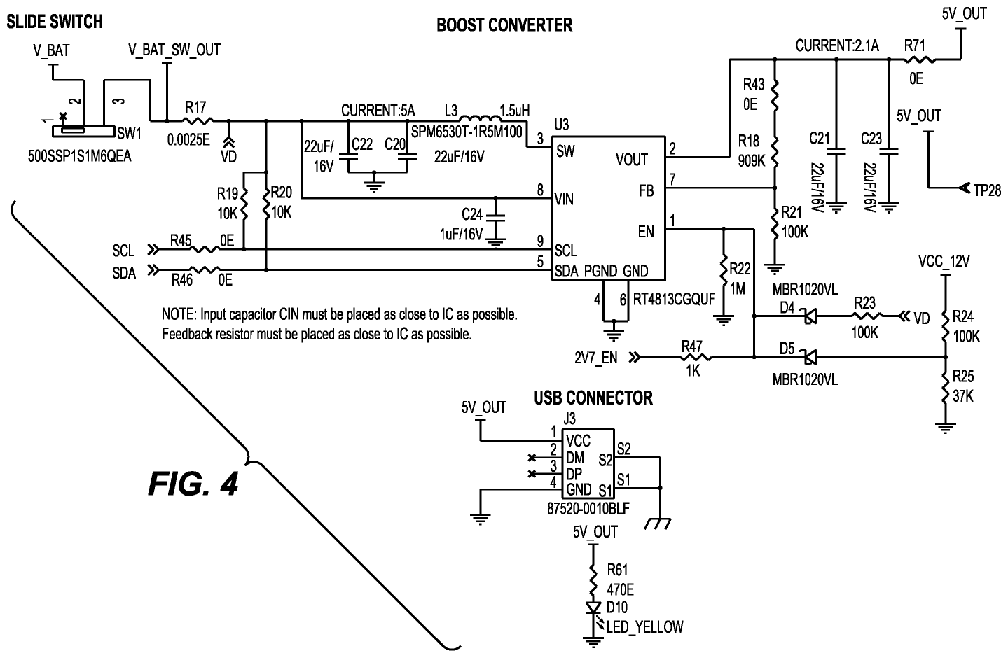

Now referring to FIG. 4, a detailed schematic drawing of boost convertor circuit 108 is shown, as well as USB connector 109 of FIG. 1, seen as jack J3 in the detailed schematic of FIG. 4. Additionally switch 106 of FIG. 1 is shown, seen as switch SW1 in the detailed schematic of FIG. 4. Current from the positive terminal of lithium-titanate battery 112, after passing through resistor R7 (seen in FIG. 2) arrives at pin 2 of switch SW1. When switch SW1 is closed, the current passes through resistor R17 and inductor L3 into pin 3 (SW) of boost convertor U3. In this embodiment, boost convertor U3 is a Richtek part number RT4813GQUF. The 5 VDC output of boost convertor U3 is found on pin 2 (VOUT). After passing through resistor R71, the 5 VDC is connected to pin 1 of jack J3 (a standard USB connector). An external device connected to jack J3 will receive the 5 VDC (up to 2 A current) for use in its own circuitry. The well-known support components for boost convertor U3 can also be seen in the circuit detailed in the schematic of FIG. 4.

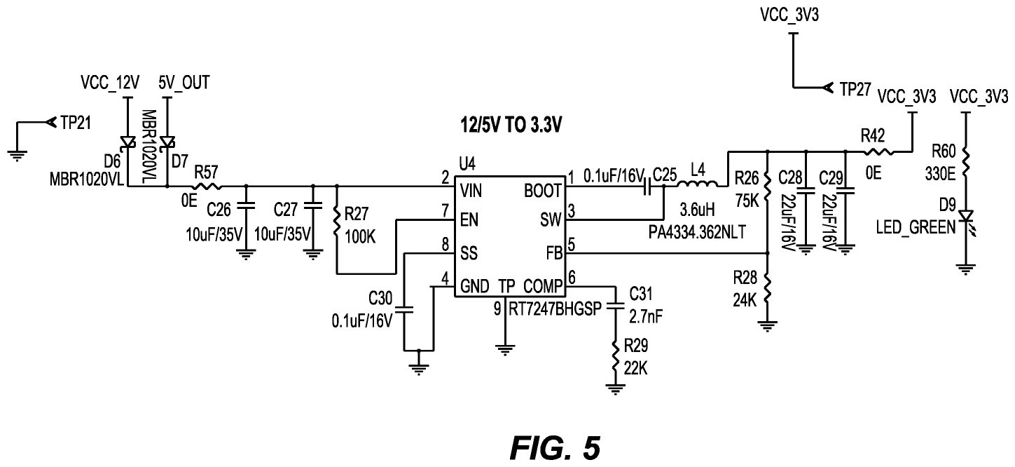

FIG. 5 is a detailed schematic drawing of 12V/5V to 3.3V regulator circuit 104 is shown. This view shows that the 12V from DC connector 101 (seen in FIG. 1) passes through diode D6 and resistor R57, and is then connected to pin 2 (VIN) of buck switching regulator U4. In this embodiment, buck switching regulator U4 is a Richtek part number RT7247BHGSP. Additionally, the 5 VDC output from boost convertor circuit 108 (seen in FIG. 1) passes through diode D7 and resistor R57, and then is connected to pin 2 (YIN) of buck switching regulator U4. Buck switching regulator U4 downconverts both the 12 VDC input power and 5 VDC output power to 3.3 VDC. The 3.3 VDC output is found on pin 3 (SW) of buck switching regulator U4. From pin 3 (SW) of buck switching regulator U4, the 3.3 VDC passes through inductor L4 and resistor R42 to provide power to microcontroller 114 as well as OLED display 113.

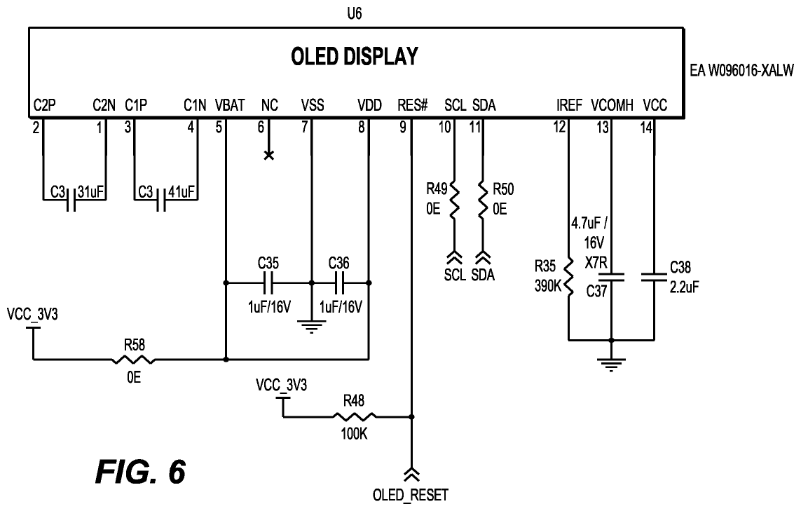

Looking now at FIG. 6, a detailed schematic drawing of OLED display 113 and its well-known support components is shown. In this schematic, OLED display 113 is shown as display U6. In this embodiment display U6 is a Electronic Assembly part number EA W096016-XALB. Microcontroller 114 (seen in FIG. 1) provides a serial clock signal to display U6 through resistor R49 onto pin 10 (SCL) of display U6, a serial data signal to display U6 through resistor R50 onto pin 11 of display U6, and an OLED reset signal directly to pin 9 of display U6. In this manner, microcontroller 114 clears the display data, and then loads new display data into display U6 using an I2C serial communications protocol. The remaining well-known support components for display U6 are also shown in the detailed schematic of FIG. 6.

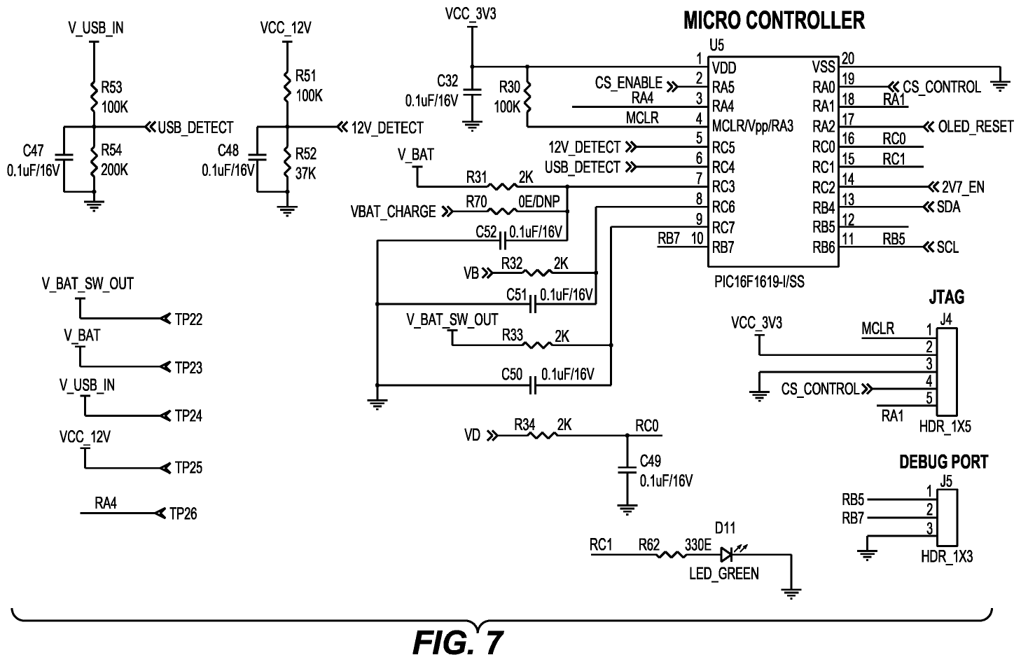

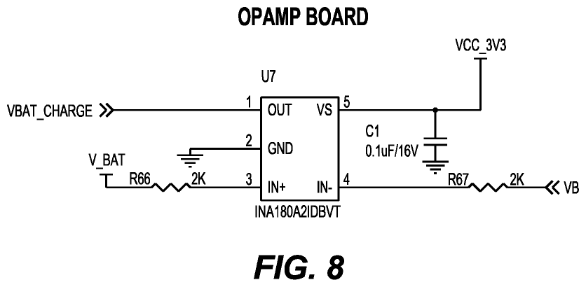

Referring next to FIG. 7, a detailed schematic drawing of microcontroller 114 and its well-known supporting components is shown. In this embodiment, microcontroller 114 is a Microchip part number PIC16F1619-I/SS. The firmware that operates on microcontroller 114 controls the process of charging and discharging of lithium-titanate battery 112, and also monitors various voltage levels of the circuitry of the present invention. This schematic details the input and output signals of microcontroller 114. These input and output signals include: (a) Pin 1 (VDD) receives a 3.3 VDC power source from buck switching regulator U4 of FIG. 5; (b) Pin 2 (RA5) sends a CS_ENABLE signal to programmable current controller U1 of FIG. 2; (c) Pin 5 (RC5) receives a 12V_DETECT signal from resistor network R51 and R52; (d) Pin 6 (RC4) receives a USB_DETECT signal from resistor network R53 and R54; (e) Pin 7 (RC3) receives a VBAT_CHARGE signal from opamp U7 of FIG. 8; (f) Pin 8 (RC6) sends a VB signal to opamp U7 of FIG. 8; (g) Pin 9 (RC7) receives a VBAT_SW_OUT signal from pin 3 of SW1 of FIG. 2; (h) Pin 11 (RB6) sends a SCL signal to display U6 of FIG. 6 and boost convertor U3 of FIG. 2; (i) Pin 13 (RB4) sends a SDA signal to display U6 of FIG. 6 and boost convertor U3 of FIG. 2; (j) Pin 14 (RC2) sends a 2V7_EN signal to boost convertor U3 of FIG. 2; (k) Pin 17 (RA2) sends an OLED_RESET signal to display U6 of FIG. 6; (l) Pin 19 (RA0) sends an CS_CONTROL signal to programmable current controller U1 of FIG. 2.

Turning our attention now to FIG. 8, there is shown a detailed schematic drawing of opamp U7 and its supporting components is shown. In this embodiment, opamp U7 is a Texas Instruments part number INA180A2IDBVT. Opamp U7 compares voltages present on pin 3 (IN+) where the battery voltage (V_BAT) of lithium-titanate battery 112 is present, and pin 5 (IN−) where the VB signal is present. The difference between these two voltages determines the value of the output VBAT_CHARGE of opamp U7 (on pin 1 (OUT)) that is sent to microcontroller 114 of FIG. 7.

### Microcontroller Firmware Operation

Referring now back to FIG. 1, the key relevant functions performed by the firmware operating on microcontroller 114 are summarized here.

First, monitor the input condition of any voltage present at the input pin of DC connector 101.

Second, monitor the input condition of any voltage present at the input pin of micro-USB connector 102.

Third, control the operation of programmable current source circuit 105.

Fourth, real-time monitoring of the voltage conditions present on each side of resistive circuit 111 (Va and Vb).

Fifth, real-time monitoring of the voltage conditions present on each side of resistive circuit 107 (Vc and Vd).

Sixth, control the operation of boost convertor 108.

Seventh, control the operation of OLED display 113.

Utilizing the monitoring and control functions described above, microcontroller 114 manages the processes used to charge lithium-titanate battery 112, causing lithium-titanate battery 112 to be charged as rapidly and safely as is practical.

Referring again to FIG. 1, further details of the firmware operation on microcontroller 114 are provided here.

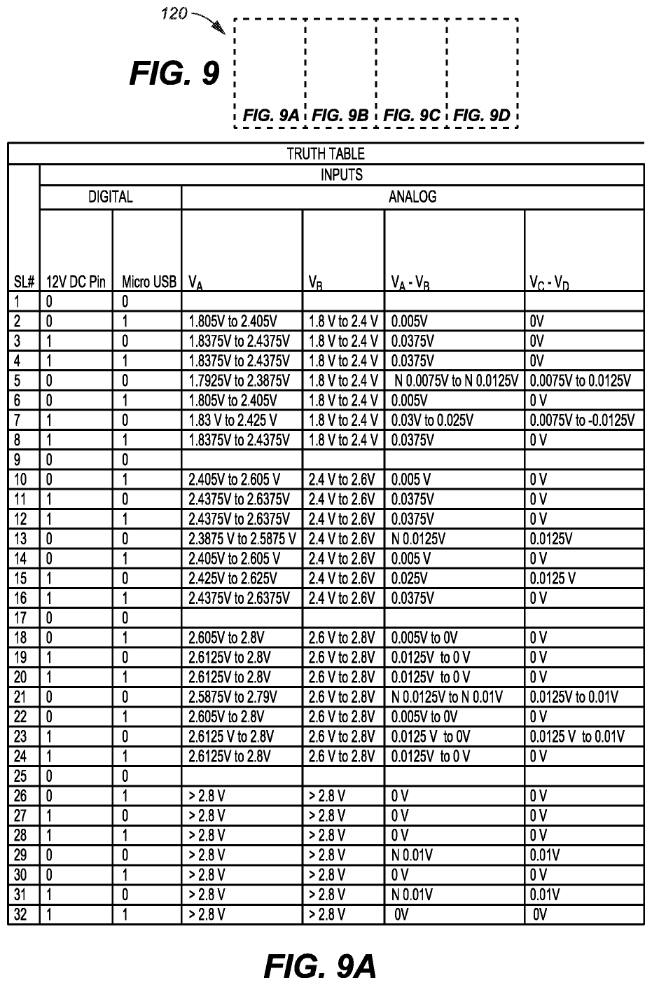

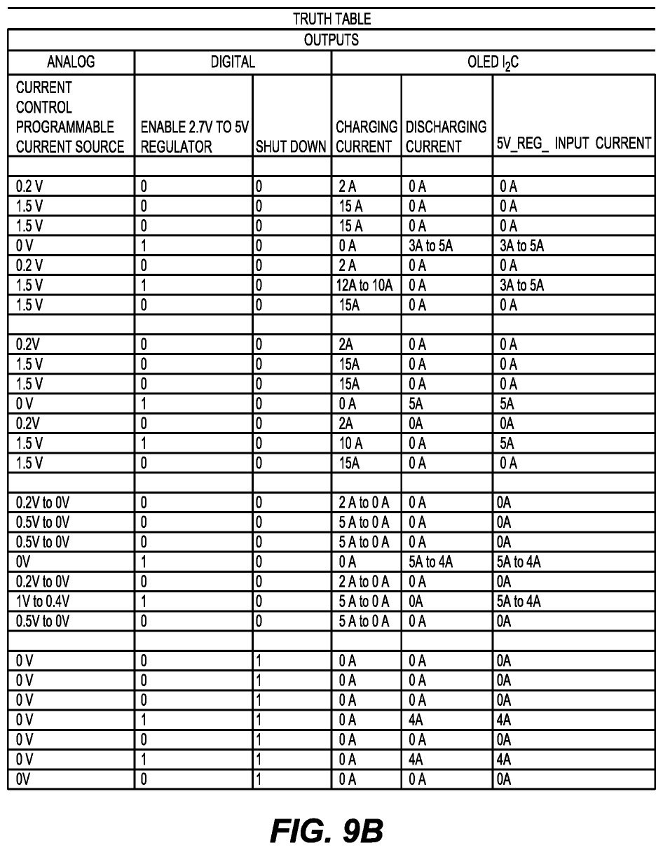

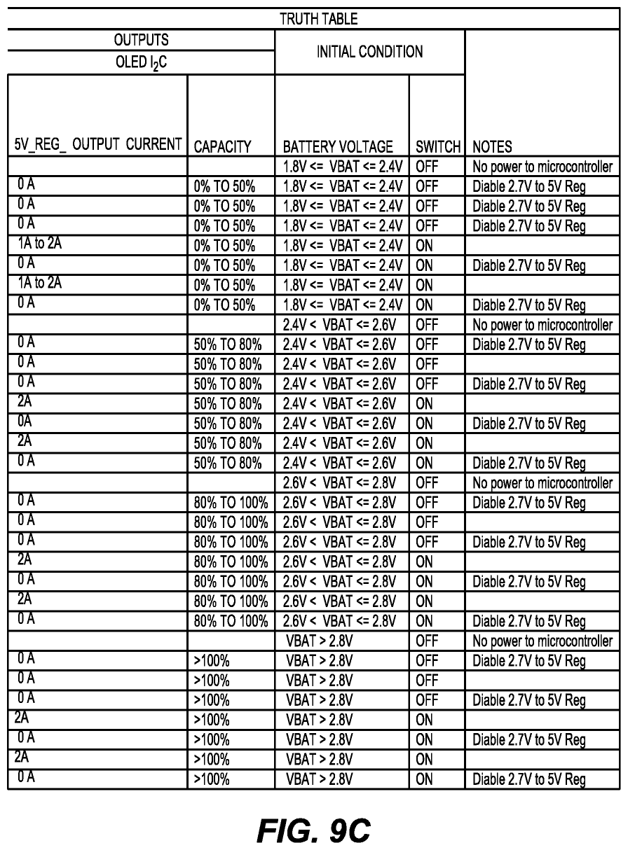

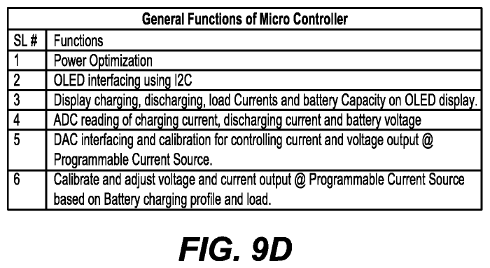

Referring, finally, to FIGS. 9A-9D, there is shown a truth table 120 and a listing 122 of general functions for the microcontroller. The table is divided left to right, thus shown in its entirety, and describes the logical design of the system, such that functional values are processed and decisions and actions taken in accordance with the invention to manage, optimize, and expedite charging current to a single cell lithium-titanate battery. The microcontroller logic is defined by a voltage threshold considered with background impedance and temperature measurements. As can be seen from the table, when battery voltage is between 1.8 and 2.4 volts and the delta between Va and Vb is less than 0.05 volts, charge input current can be increased to an initial level of 5-11 amps, depending on impedance. When battery voltage is between 2.4 and 2.6 volts and the delta of Va and Vb is less than 0.05 volts, input charging current can be increased between 11-15.6 Amps. When battery voltage is between 2.6 and 2.8 volts and delta of Va and Vb is less than 0.05 volts, input charging current is decreased to between 5-9 Amps. If the voltage is above 2.8 volts, current is decreased to 0 amps.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. An electronic circuit for managing charging current to a single-cell lithium-titanate battery, comprising:
one or more inputs that provide power for charging the lithium-titanate battery cell;
an output for transferring power from the lithium-titanate battery to an external device; and
a microcontroller for performing real-time continuous monitoring of battery voltage, charging current, and internal resistance, said microcontroller programmed to determine when to increase the charging current to the lithium-titanate battery to reduce the time it takes for the battery to become fully charged, wherein the charging time for fully charging a fully depleted battery is less than 15 minutes.
